(19) United States
(12) Patent Application Publication
(10) Pub. No.: US 2021/0086493 A1
(43) Pub. Date: Mar. 25, 2021

(54) RFID Tag with Coated Paper as The Base Material and Making method Thereof

(71) Applicant: Jiangsu keruitan Electronic Technology Co., Ltd, Taizhou City (CN)

(72) Inventors: Bin Sun, Taizhou City (CN); Jian He, Taizhou City (CN)

(73) Assignee: Jiangsu keruitan Electronic Technology Co., Ltd, Taizhou City (CN)

(21) Appl. No.: 17/025,673

(22) Filed: Sep. 18, 2020

(30) Foreign Application Priority Data
Sep. 20, 2019 (CN) 201910893187.5

(51) Int. Cl. B32B 29/00; G06K 19/077

(52) U.S. Cl. CPC B32B 29/002; G06K 19/07745; G06K 19/07749; B32B 2367/00; B32B 2255/12; B32B 2363/00; B32B 2457/00

(57) ABSTRACT

The invention provides an RFID tag with coated paper as the base material, comprising: an IC Chip, an antenna layer, a glue layer and a corrosion resistant paper arranged in order from top to bottom, said antenna layer binds said IC Chip, said antenna layer is linked with said corrosion resistant paper through said glue layer, said corrosion resistant paper is composed of coated paper coated with corrosion resistant coating on both sides. The beneficial effects of the invention are as follows: using coated paper instead of PET film as the base material of RFID tag, the new RFID tag with low price and high performance is made by using its flat surface, high temperature resistance, easy decomposition and environmental protection. It simplifies the process flow and eliminates the process of sticking the label on the label paper. As the direct base material of RFID tag, the chip can be directly used after the chip is bound to the antenna.

### Field of the Invention

The present invention relates to field of the radio frequency communication technology, more specifically relating to an RFID tag with coated paper as the base material and making method thereof.

### BACKGROUND OF THE INVENTION

RFID technology has been widely used in: access control, air parcel identification, document tracking management, package tracking identification, logistics management, mobile commerce, product anti-counterfeiting, movement timing, ticket management, car chip anti-theft device, parking lot control, production line automation, material management and so on, which will become an integral part of our lives.

At present, the antenna production adopted by RFID tag industry is as follows: 1) PET film is selected as the main substrate of antenna; 2) The aluminum foil is glued onto the PET film to obtain the semi-finished antenna (composite membrane) through the dry laminating machine; 3) Printing antenna pattern on semi-finished antenna and then through the printing machine; 4) The pattern on the semi-finished antenna is made into an etching antenna by etching; 5) The chip is bound on the aluminum foil surface of the antenna to form an RFID tag; 6) Stick the RFID tag on the label paper for use.

However, the main disadvantages of this process are as follows: 1) PET film has poor adhesion, smooth surface and no printing function, which is not conducive to the following development of the industry; 2) PET film is easy to generate static electricity in the process of winding and unwinding, which can not effectively remove static electricity in high-speed winding mode, which is easy to cause damage to antenna products; 3) The PET film has poor temperature resistance. When the antenna is processed into a label, it will shrink and deform seriously, which will cause the appearance and performance of the tag to be poor; 4) PET film is mainly composed of polyethylene terephthalate, which is not easy to decompose and is not conducive to environmental protection; 5) The RFID tag made of PET film can't be used directly. It needs secondary processing to the prepared Lable paper, and the cost is high.

### SUMMARY OF THE INVENTION

The invention overcomes the shortcomings of the prior art. One of the purposes of the invention is to provide an RFID tag with coated paper as the base material, and the other object of the invention is to provide a making method of RFID tag with coated paper as the base material. The object of the invention is realized by the following technical scheme.

An RFID tag with coated paper as the base material, comprising: an IC Chip, an antenna layer, a glue layer and a corrosion resistant paper arranged in order from top to bottom, said antenna layer binds said IC Chip, said antenna layer is linked with said corrosion resistant paper through said glue layer, said corrosion resistant paper is composed of coated paper coated with corrosion resistant coating on both sides.

Further, said coated paper is double-sided coated paper.

Further, said antenna layer is aluminum foil or copper foil.

Further, said glue layer is composed of glue, curing agent and solvent by mixing and stirring, the ratio of glue, curing agent and solvent is 10:0.8:6, and the stirring time is 30 min.

Further, said glue is SanJing PP5430, said curing agent is I-3000, said solvent is ethyl acetate.

Further, said corrosion resistant coating is composed of polyester resin 30-40 parts, bisphenol A cyanic acid resin 5-10 parts, acrylic resin 5-10 parts. alkyd resin 1-3 parts, epoxy resin 1-2 parts, defoamer 0.5-2 parts, ethyl acetate 40-50 parts.

A making method of an RFID tag with coated paper as the base material, comprising the following steps of:

Step 1): making waterproof, acid and alkali resistant corrosion resistant paper;

Step 2): making RFID antenna;

Step 3): making RFID tag.

Further, the, making method of waterproof, acid and alkali resistant corrosion resistant paper in step 1) is to coat ,the front and back sides of the double-sided coated paper with corrosion resistant coating by a coating machine.

Further, said corrosion resistant coating is composed of polyester resin 30-40 parts, bisphenol A cyanic acid resin 5-10 parts, acrylic resin 5-10 parts, alkyd resin 1-3 parts, epoxy resin 1-2 parts, defoamer 0.5-2 parts, ethyl acetate 40-50 parts.

Further, the coating amount of said coating machine reaches 9-15 g/m².

Further, the drying channel temperature of said coating machine is 90-150 , the coating speed is 25-35 m/min, and the coating pressure is 0.5-0.7 MPA.

Further, the making method of RFID antenna in step 2) is:

step (1): the semi-finished product of paper antenna is made by compounding aluminum foil or copper foil with corrosion-resistant paper through the laminating machine;

step (2): the antenna pattern is printed on the semi-finished product of corrosion-resistant paper antenna by printing machine;

step (3): the pattern on the semi-finished product of the corrosion-resistant paper antenna is made into an etching antenna by an etching machine.

Further, the stripping force between said aluminum foil or copper foil and said corrosion resistant paper is 4±1 N/15 mm.

Further, the composite temperature is 70-90° C., the curing temperature is 50±5° C., and the curing time is not less than 96 h.

Further, the glue layer in step (1) is composed of glue, curing agent and solvent by mixing and stirring, the ratio of glue, curing agent and solvent is 10:0.8:6, and the mixing time is 30 min.

Further, the glue is SanJing PP5430.

Further, the curing agent is 1-3000.

Further, the solvent is ethyl acetate.

Further, the making method of RFID tag in step 3) is to use, the RFID antenna obtained in step 2) to bind the chip to form an RFID tag.

Further, during the binding, the hot pressing temperature is 18±5° C., the hot pressing pressure is 0.5-1 N, the hot pressing time is 7-8 s, and the test frequency is 860-960 MHZ.

The beneficial effects of the invention are as follows: the RFID UHF tag antenna using coated paper as the base material has the following advantages:

1. Coated paper can be directly printed on the surface, so it increases the choice of customers and is conducive to the development of the industry;

2. The coated paper does not produce static electricity and will not damage the antenna products; 3. The coated paper can withstand high temperature, and it will not shrink and deform within 200° C. It can fully meet the high temperature heating of antenna in the process of label processing;

4. The coated paper is mainly composed of cellulose, hemicellulose and lignin, which is easy to decompose and is conducive to environmental protection;

5. Simplify the process, remove the label secondary processing process.

### BRIEF DESCRIPTION OF THE DRAWINGS

FIG. 1 is a structural diagram of the RFID electronic tag of the invention.

In the picture:

1—IC Chip:

2—antenna layer:

3—glue layer:

4—corrosion resistant paper;

5—coated paper;

6—corrosion resistant coating.

### DETAILED EMBODIMENTS

The technical scheme of the invention is further explained by specific examples.

Composition of coated paper

An RFID tag with coated paper as the base material, comprising: an IC Chip, an antenna layer, a glue layer and a corrosion resistant paper arranged in order from top to bottom, said antenna layer binds said IC Chip, said antenna layer is linked with said corrosion resistant paper through said glue layer, said corrosion resistant paper is composed of coated paper coated with corrosion resistant coating on both sides.

The coated paper is double-sided coated paper.

The antenna layer is aluminum foil or copper foil.

The glue layer is composed of glue, curing agent and solvent by mixing and stirring, the ratio of glue, curing agent and solvent is 10:0.8:6, and the stirring time is 30 min. The glue is SanJing PP5430, the curing agent is I-3000, the solvent is ethyl acetate.

The corrosion resistant coating is composed of polyester resin 30-40 parts, bisphenol A cyanic acid resin 5-10 parts, acrylic resin 5-10 parts, alkyd resin 1-3 parts, epoxy resin 1-2 parts, defoamer 0.5-2 parts, ethyl acetate 40-50 parts.

The corrosion resistant coating has good water resistance, acid and alkali resistance and leveling property, the 3# Zahn viscosity cups testing is 50±5 S, to ensure the required coating amount. It can effectively protect the substrate from acid and alkali, high temperature, water vapor and other erosion. After coating, the surface can be printed with clear text and image.

Using coated paper instead of PET film as the base material of RFID tag, the new RFD tag with low price and high performance is made by using its flat surface, high temperature resistance, easy decomposition and environmental protection. It simplifies the process flow and eliminates the process of sticking the label on the label paper. As the direct base material of RFID tag, the chip can be directly used after the chip is bound to the antenna.

### Making Method of Coated Paper

A making method of an RFID tag with coated paper as the base material, comprising the following steps of:

Step 1): making waterproof, acid and alkali resistant corrosion resistant paper. The making method of waterproof, acid and alkali resistant corrosion resistant paper is to coat the front and back sides of the double-sided coated paper with a corrosion resistant coating. Said corrosion resistant coating is composed of polyester resin 30-40 parts, bisphenol A cyanic acid resin 5-10 parts, acrylic resin 5-10 parts, alkyd resin 1-3 parts, epoxy resin 1-2 parts, defoamer 0.5-2 parts, ethyl acetate 40-50 parts.

The stripping force between said aluminum foil or copper foil and said corrosion resistant paper is 4±1 N/15 mm The composite temperature is 70-90° C., the curing temperature is 50±5° C., and the curing time is not less than 96 h.

step 2): making RFID antenna. The making method of RFID antenna is:

step (1): the semi-finished product of paper antenna is made by compounding aluminum foil or copper foil with corrosion-resistant paper through the laminating machine; step (2): the antenna pattern is printed on the semi-finished product of corrosion-resistant paper antenna by printing machine; step (3): the pattern on the semi-finished product of the corrosion-resistant paper antenna is made into an etching antenna by an etching machine. The glue layer is composed of glue, curing agent and solvent by mixing and stirring, the ratio of glue, curing agent and solvent is 10:0.8:6, the mixing time is 30 min. The glue is SanJing PP5430, the curing agent is 1-3000, the solvent is ethyl acetate.

Step 3): making RFID tag. The making method of RFID tag is to use the RFD antenna obtained in step 2) to bind the chip to form an RFID tag.

During the binding, the hot pressing temperature is 180 ±5° C., the hot pressing pressure is 0.5-1 N, the hot pressing time is 7-8 s, and the test frequency is 860-960 MHZ.

The coating amount of said coating machine reaches 9-15 g/m², the drying channel temperature is 90-150° C., the coating speed is 25-35 m/min, and the coating pressure is 0.5-0.7 MPA.

1) Using coated paper instead of PET film as the base material of RFID tag, the new RFID tag with low price and high performance is made by using its flat surface, high temperature resistance, easy decomposition and environmental protection.

2) It simplifies the process flow and eliminates the process of sticking the label on the label paper. As the direct base material of RFID tag, the chip can be directly used after the chip is bound to the antenna.

### Embodiment 1

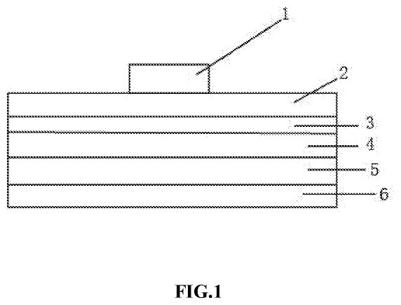

The present embodiment is an RFID tag with coated paper as the base material, the structural diagram is shown as FIG. 1, comprising an IC Chip 1, an antenna layer 2, a glue layer 3 and a corrosion resistant paper 4 arranged in order from top to bottom, said antenna layer 2 binds said IC Chip 1, said antenna layer 2 is linked with said corrosion resistant paper 4 through said glue layer 3, said corrosion resistant paper 4 is composed of coated paper 5 coated with corrosion resistant coating 6 on both sides.

The coated paper 5 is double-sided coated paper.

The glue layer 3 is composed of glue, curing agent and solvent by mixing and stirring, the ratio of glue, curing agent and solvent is 10:0.8:6, the mixing time is 30 min. The glue is SanJing PP5430, the curing agent is 1-3000, the solvent is ethyl acetate.

The corrosion resistant coating is composed of polyester resin 30 parts, bisphenol A cyanci acid resin 5 parts, acrylic resin 5 parts, alkyd resin 1 parts, epoxy resin 1 parts, defoamer 0.5 parts, ethyl acetate 40 parts.

The making method of an RFID tag with coated paper as the base material, comprising the following steps of:

Step 1): making waterproof, acid and alkali resistant corrosion resistant paper. The making method of waterproof, acid and alkali resistant corrosion resistant paper is to coat the front and back sides of the double-sided coated paper with a corrosion resistant coating. Said corrosion resistant coating is composed of polyester resin 30 parts, bisphenol A cyanic acid resin 5 parts, acrylic resin 5 parts, alkyd resin 1 parts, epoxy resin 1 parts, defoamer 0.5 parts, ethyl acetate 40 parts.

The stripping force between said aluminum foil or copper foil and said corrosion resistant paper is 3 N/15 mm. The composite temperature is 70° C., the curing temperature is 45° C., and the curing time is 96 h.

step 2): making RFID antenna. The making method of RFID antenna is:

step (1): the semi-finished product of paper antenna is made by compounding aluminum foil or copper foil with corrosion-resistant paper through the laminating machine; step (2): the antenna pattern is printed on the semi-finished product of corrosion-resistant paper antenna by printing machine; step (3): the pattern on the semi-finished product of the corrosion-resistant paper antenna is made into an etching antenna by an etching machine. The glue layer is composed of glue, curing agent and solvent by mixing and stirring, the ratio of glue, curing agent and solvent is 10:0.8:6, the mixing time is 30 min. The glue is SanJing PP5430. The curing agent is 1-3000. The solvent is ethyl acetate.

Step 3): making RFID tag. The making method of RFID tag is to use the RFID antenna obtained in step 2) to bind the chip to form an RFID tag.

During the binding, the hot pressing temperature is 175° C., the hot pressing pressure is 0.5 N, the hot pressing time is 7 s, and the test frequency is 860 MHZ.

The coating amount of said coating machine reaches 9 g/m², the drying channel temperature is 90° C., the coating speed is 25 m/min, and the coating pressure is 0.5 MPA.

### Embodiment 2

Different from embodiment 1 is, the corrosion resistant coating is composed of polyester resin 40 parts, bisphenol A cyanic acid resin 10 parts, acrylic resin 10 parts, alkyd resin 3 parts, epoxy resin 2 parts, defoamer 2 parts, ethyl acetate 50 parts.

The stripping force between said aluminum foil or copper foil and said corrosion resistant paper is 5 N/15 mm. The composite temperature is 90° C., the curing temperature is 55° C., and the curing time is 98 h.

The hot pressing temperature is 185° C., the hot pressing pressure is 1 N, the hot pressing time is 8 s, and the test frequency is 960 MHZ.

The coating amount of said coating machine reaches 15 g/m², the drying channel temperature is 150° C., the coating speed is 35 m/min, and the coating pressure is 0.7 MPA.

### Embodiment 3

Different from embodiment 1 is, the corrosion resistant coating is composed of polyester resin 35 parts, bisphenol A cyanic acid resin 8 parts, acrylic resin 8 parts, alkyd resin 2 parts, epoxy resin 1.5 parts, defoamer 1 parts, ethyl acetate 45 parts.

The stripping force between said aluminum foil or copper foil and said corrosion resistant paper is 5 N/15 mm. The composite temperature is 80° C., the curing temperature is 52° C., and the curing time is not less than 1 h.

The hot pressing temperature is 182° C. the hot pressing pressure is 0.8 N, the hot pressing time is 7.5 s, and the test frequency is 900 MHZ.

The coating amount of said coating machine reaches 13 g/m², the drying channel temperature is 100° C., the coating speed is 30 m/min, and the coating pressure is 0.6 MPA.

### Embodiment 4

Different from embodiment 1 is, the corrosion resistant coating is composed of polyester resin 25 parts, bisphenol A cyanic acid resin 4 parts, acrylic resin 4 parts, alkyd resin 0.5 parts, epoxy resin 0.5 parts, defoamer 0.2 parts, ethyl acetate 35 parts.

### Embodiment 5

Different from embodiment 1 is, the corrosion resistant coating is composed of polyester resin 45 parts, bisphenol A cyanic acid resin 12 parts, acrylic resin 12 parts, alkyd resin 3.5 parts, epoxy resin 2.5 parts, defoamer 2.5 parts, ethyl acetate 55 parts.

### Experimental Verification

1. Whether the RFID tag is deformed at different temperatures:

The temperature values are 50° C., 80° C., 100° C., 120° C., 150° C., 180° C., 200° C., 220° C., and the experimental results are shown in Table 1;

2. The results of stripping force test are shown in Table 2.

TABLE 1
Test results of RFID tag deformation at different temperatures

| | Test result | | | | | | | |
|---|---|---|---|---|---|---|---|---|
| Test number | 50° C. | 80° C. | 100° C. | 120° C. | 150° C. | 180° C. | 200° C. | 220° C. |
| Embodiment 1 | No | No | No | No | No | No | Yes | Yes |
| Embodiment 2 | No | No | No | No | No | No | Yes | Yes |
| Embodiment 3 | No | No | No | No | No | No | Yes | Yes |
| Embodiment 4 | No | No | No | No | No | No | Yes | Yes |
| Embodiment 5 | No | No | No | No | No | No | Yes | Yes |

TABLE 2
Test results of stripping force test

| | Test result |
|---|---|
| Test number | stripping force |
| Embodiment 1 | 4N/15 mm |
| Embodiment 2 | 5N/15 mm |
| Embodiment 3 | 5N/15 mm |
| Embodiment 4 | 2N/15 mm |
| Embodiment 5 | 10N/15 mm |

The RFID tags of embodiments 1-5 can adapt to high temperature working environment.

The RFID tags of embodiments 1-3 have good stripping force; the stripping force of embodiment 4 is too small, which is easy to fall off; the stripping force of embodiment 5 is large, which is not easy to peel off in actual work.

The above five embodiments of the invention have been described in detail, but the contents are only better embodiments of the invention and cannot be considered as limiting the implementation scope of the invention. All equal changes and improvements made according to the application scope of the invention shall still belong to the scope of the patent of the invention.

1. An RFID tag with coated paper as the base material, comprising: an IC Chip, an antenna layer, a glue layer and a corrosion resistant paper arranged in order from top to bottom, said antenna layer binds said IC Chip, said antenna layer is linked with said corrosion resistant paper through said glue layer, said corrosion resistant paper is composed of coated paper coated with corrosion resistant coating on both sides.

2. The RFID tag with coated paper as the base material according to claim 1, wherein said coated paper is double-sided coated paper.

3. The RFID tag with coated paper as the base material according to claim 1, wherein said antenna layer is aluminum foil or copper foil.

4. The RFID tag with coated paper as the base material according to claim 1, wherein said glue layer is composed of glue, curing agent and solvent by mixing and stirring, the ratio of glue, curing agent and solvent is 10:0.8:6, and the stirring time is 30 min.

5. The RFID tag with coated paper as the base material according to claim 4, wherein said glue is SanJing PP5430, said curing agent is I-3000, said solvent is ethyl acetate.

6. The RFID tag with coated paper as the base material according to claim 1, wherein said corrosion resistant coating is composed of polyester resin 30-40 parts, bisphenol A cyanic acid resin 5-10 parts, acrylic resin 5-10 parts, alkyd resin 1-3 parts, epoxy resin 1-2 parts, defoamer 0.5-2 parts, ethyl acetate 40-50 parts.

7. A making method of an RFD tag with coated paper as the base material, comprising the following steps of:
Step 1): making waterproof, acid and alkali resistant corrosion resistant paper;
Step 2): making RFID antenna;
Step 3): making RFID tag.

8. The making method of an RFID tag with coated paper as the base material according to claim 7, wherein the making method of waterproof, acid and alkali resistant corrosion resistant paper in step 1) is to coat, the front and back sides of the double-sided coated paper with corrosion resistant coating by coating machine.

9. The making method of an RFID tag with coated paper as the base material according to claim 8, wherein said corrosion resistant coating is composed of polyester resin 30-40 parts, bisphenol A cyanic acid resin 5-10 parts, acrylic resin 5-10 parts, alkyd resin 1-3 parts, epoxy resin 1-2 parts, defoamer 0.5-2 parts, ethyl acetate 40-50 parts.

10. The making method of an RFID tag with coated paper as the base material according to claim 7, wherein the making method of RFID antenna in step 2) is:
Step (1): the semi-finished product of paper antenna is made by compounding aluminum foil or copper foil with corrosion-resistant paper through the laminating machine;
Step (2): the antenna pattern is printed on the semi-finished product of corrosion-resistant paper antenna by printing machine;
Step (3): the pattern on the semi-finished product of the corrosion-resistant paper antenna is made into an etching antenna by an etching machine.

11. The making method of an RFID tag with coated paper as the base material according to claim 8, wherein the coating amount of said coating machine reaches 9-15 g/m².

12. The making method of an RFID tag with coated paper as the base material according to claim 8, wherein the drying channel temperature of said coating machine is 90-150° C., the coating speed is 25-35 m/min, and the coating pressure is 0.5-0.7 MPA.

13. The making method of an RFID tag with coated paper as the base material according to claim 10, wherein the stripping force between said aluminum foil or copper foil and said corrosion resistant paper is 4±1 N/15 mm.

14. The making method of an RFID tag with coated paper as the base material according to claim 10, wherein the composite temperature is 70-90° C., the curing temperature is 50±5° C. and the curing time is not less than 96 h.

15. The making method of an RFID tag with coated paper as the base material according to claim 7, wherein the making method of RFID tag in step 3) is to use, the RFID antenna obtained in step 2) to bind the chip to form an RFID tag.

16. The making method of an RFID tag with coated paper as the base material according to claim 7, wherein during the binding, the hot pressing temperature is 18±5° C. the hot pressing pressure is 0.5-1 N, the hot pressing time is 7-8 s, and the test frequency is 860-960 MHZ.
